(19) United States
(12) Patent Application Publication
(10) Pub. No.: US 2026/0338209 A1
(43) Pub. Date: Oct. 29, 2026

(54) SYSTEM FOR OPERATING HYDRAULIC ACTUATORS

(71) Applicant: Caterpillar Inc., Peoria, IL (US)

(72) Inventors: Anand SUBBIAH PREMA, Chennai (IN); Prasana R., Chennai (IN); Jegatheesh CHIDAMBARAM, Nagercoil (IN); Partiban CHENGALVARAYAN, Chennai (IN)

(21) Appl. No.: 19/486,119

(22) PCT Filed: May 13, 2024
(86) PCT No.: PCT/US2024/029053

§ 371 Date: Nov. 20, 2025

(30) Foreign Application Priority Data
Jun. 2, 2023 (AU) 2023203455

(51) Int. Cl. F15B 15/16; F15B 13/02

(52) U.S. Cl. CPC F15B 15/16; F15B 13/024

(57) ABSTRACT

A system for operating a hydraulic actuator. The system comprising a fluid chamber, one or more cushioning orifices fluidly coupled between the fluid chamber, and a cavity defined between a piston and an end structure of the hydraulic actuator. Each of the one or more cushioning orifices is configured to provide an exit passage to a first volume of a fluid pressurized in the cavity into the fluid chamber during a movement of the piston towards the end structure to cushion the piston against an impact with the end structure. The system further includes a fluid pressure relief mechanism configured to relieve a second volume of the fluid in excess of the first volume of the fluid when a pressure of the fluid in the one or more cushioning orifices or the cavity reaches or exceeds a threshold pressure value during the movement of the piston towards the end structure.

### TECHNICAL FIELD

The present disclosure relates to hydraulic actuators. More particularly, the present disclosure relates to a system for operating the hydraulic actuator to relieve a cushion pressure in the hydraulic actuator.

### BACKGROUND

Work machines, such as, dozers, loaders, excavators, motor graders, drills, rigs, and other types of heavy machinery use one or more work implements to accomplish a variety of tasks. These work implements are often actuated using hydraulic actuators having a cylinder and a piston assembly. The piston assembly may move within the cylinder to pressurize a fluid housed within the cylinder. As the piston assembly moves towards an end of its stroke, e.g., an expansion stroke, the piston assembly may push the fluid into one or more surrounding passages through one or more orifices. When the piston assembly nears the end, some of the orifices may be closed or their flow areas may be reduced, thus intensifying the fluid pressure and slowing down the progress of the piston assembly towards the end of its stroke. An unattended pressure intensification may yield the material of the piston assembly and also lead to a reduced lifespan of the piston assembly and/or the cylinder.

Japanese publication 2003056515 discloses a hydraulic cylinder with a cushion mechanism configured to provide a cushion to the piston at the end of the stroke. The hydraulic cylinder includes a pressure relief valve disposed inside a piston of the hydraulic assembly and the pressure relief valve opens when the cushion pressure exceeds a predetermined value, so that the oil pressure on the rod-side oil chamber is discharged to the bottom-side oil chamber, a sudden increase in the cushion pressure can be suppressed.

### SUMMARY OF THE INVENTION

In one aspect, the disclosure relates to a system for operating a hydraulic actuator. The system includes a fluid chamber, one or more cushioning orifices fluidly coupled between the fluid chamber, and a cavity defined between a piston and an end structure of the hydraulic actuator. Each of the one or more cushioning orifices is configured to provide an exit passage to a first volume of a fluid pressurized in the cavity into the fluid chamber during a movement of the piston towards the end structure to cushion the piston against an impact with the end structure. The system further includes a fluid pressure relief mechanism configured to relieve a second volume of the fluid in excess of the first volume of the fluid when a pressure of the fluid in the one or more cushioning orifices or the cavity reaches or exceeds a threshold pressure value during the movement of the piston towards the end structure.

In another aspect, the disclosure is directed to a hydraulic actuator. The hydraulic actuator includes at least one cylinder defining an end structure. The hydraulic actuator further includes a piston moveable with respect to the at least one cylinder. The piston defines a cavity with respect to the end structure. The hydraulic actuator further includes a system for operating the hydraulic actuator. The system includes a fluid chamber, one or more cushioning orifices fluidly coupled between the fluid chamber, and a cavity defined between the piston and the end structure. Each of the one or more cushioning orifices is configured to provide an exit passage to a first volume of a fluid pressurized in the cavity into the fluid chamber during a movement of the piston towards the end structure to cushion the piston against an impact with the end structure. The system further includes a fluid pressure relief mechanism configured to relieve a second volume of the fluid in excess of the first volume of the fluid when a pressure of the fluid in the one or more cushioning orifices or the cavity reaches or exceeds a threshold pressure value during the movement of the piston towards the end structure.

In yet another aspect, the disclosure is related to a work machine comprising a frame, a work implement, and a hydraulic actuator. The hydraulic actuator is configured to move the work implement with respect to the frame. The hydraulic actuator includes at least one cylinder defining an end structure. The hydraulic actuator further includes a piston moveable with respect to the at least one cylinder. The piston defines a cavity with respect to the end structure. The hydraulic actuator further includes a system for operating the hydraulic actuator. The system includes a fluid chamber, one or more cushioning orifices fluidly coupled between the fluid chamber, and a cavity defined between the piston and the end structure. Each of the one or more cushioning orifices is configured to provide an exit passage to a first volume of a fluid pressurized in the cavity into the fluid chamber during a movement of the piston towards the end structure to cushion the piston against an impact with the end structure. The system further includes a fluid pressure relief mechanism configured to relieve a second volume of the fluid in excess of the first volume of the fluid when a pressure of the fluid in the one or more cushioning orifices or the cavity reaches or exceeds a threshold pressure value during the movement of the piston towards the end structure.

### BRIEF DESCRIPTION OF THE DRAWINGS

FIG. 1 is a side view of an exemplary work machine having a work implement (e.g., mast in a raised or a vertical position), in accordance with an embodiment of the present disclosure;

FIG. 2 is a cross-sectional view of a hydraulic actuator associated with the work implement, in accordance with an embodiment of the present disclosure;

FIG. 3 is a cross-sectional view of the hydraulic actuator in a partially extended position, in accordance with an embodiment of the present disclosure;

FIG. 4 is a cross-sectional view of the hydraulic actuator in a fully extended position, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

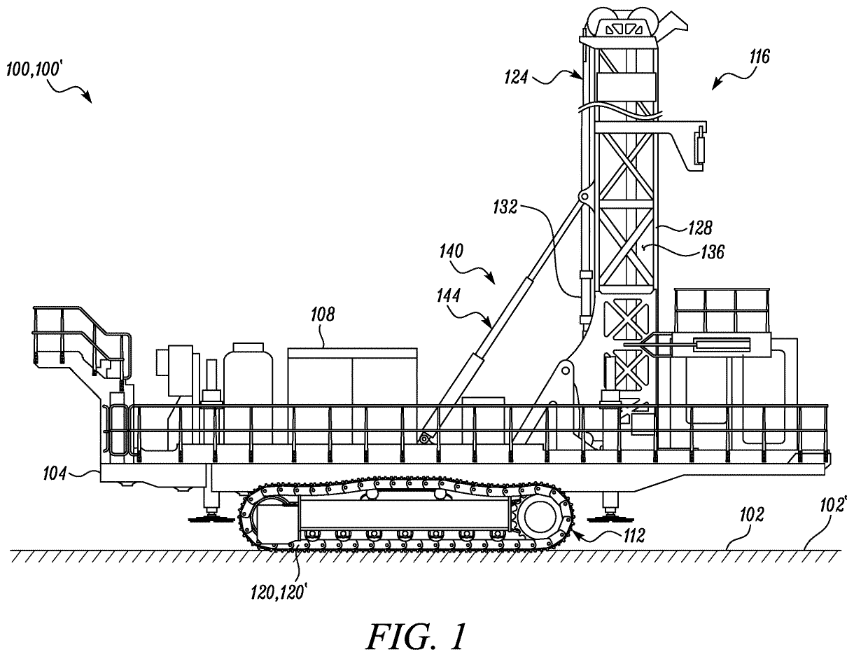

Referring to FIG. 1, an exemplary work machine 100 (hereinafter referred to as ‘machine 100’) is shown. The machine 100 may be a drilling machine 100′ which may be employed for penetrating into earth to mine for materials, such as ore, soil, debris, or other naturally occurring deposits at a jobsite 102. Alternatively, aspects of the present disclosure may be applied to any work machine that performs one or more operations associated with an industry such as mining, construction, farming, transportation, or any other industry known in the art, and which uses one or more hydraulic actuators. Therefore, the reference to the drilling machine 100′ is exemplary. For example, the machine 100 can be an excavator, a dozer, a loader, a backhoe, a motor grader, a blast-hole drilling machine, a rotary drilling machine, a surface drilling machine, or any other machine configured to perform earth moving operations.

The machine 100 includes a frame 104, a propulsion system 108, an undercarriage assembly 112, and one or more work implements (see work implement 116). The frame 104 may accommodate and/or support each of the propulsion system 108, the work implement 116, and/or the undercarriage assembly 112, although other known systems and/or components may be supported by the frame 104, as well. The propulsion system 108 may include a power source (not shown), which may include one or more of a combustion engine, an electrical power source, or a combination of both. The power source may be configured to generate power to operate various systems or assemblies of the machine 100, such as the undercarriage assembly 112 of the machine 100 to enable the machine 100 move between various locations of the jobsite 102. The undercarriage assembly 112 may include one or more endless crawler tracks 120, located on either sides of the machine 100 (only one endless crawler track 120′ is visible in the orientation of the machine 100 in FIG. 1 as one or more of the other endless crawler tracks of the machine 100 are eclipsed by the endless crawler track 120′).

The work implement 116 may include a mast assembly 124 which may include a mast 128 and a drill tool 132. The mast 128 may be formed from multiple beams, links, reinforcement members, etc., and they may be connected together (e.g., by known methods) to define an inner volume 136 of the mast 128 within which the drill tool 132 may be positioned. Further, the mast assembly 124 may be coupled and mounted to the frame 104. As an example, the mast assembly 124 may be pivotably coupled to the frame 104 to move between a raised position and a lowered position with respect to the frame 104. For example, the raised position of the mast assembly 124 may be a generally vertical position of the mast assembly with respect to an exemplary surface 102′ at the jobsite 102 and at which the machine 100 may perform a drilling operation by using the drill tool 132. As an example, the orientation of the mast assembly 124 in FIG. 1 corresponds to the raised position or the vertical position of the mast assembly 124.

The lowered position of the mast assembly 124 may be a generally horizontal or stowed position of the mast 128 in which the mast assembly 124 may be stowed and carried on the machine 100 to allow the machine 100 to tram across the jobsite 102. The term ‘generally’ used may mean ‘not strictly’ and is understandable to one skilled in the art.

The machine 100 may include an actuation system 140 to move the mast assembly 124 between the raised position and the lowered position. As an example, the actuation system 140 includes one or more actuators, e.g., two actuators, with one actuator being hidden behind another actuator, e.g., actuator 144, in the orientation of the machine 100 in FIG. 1. Forthcoming description includes discussions related to the actuator 144. Said discussions may be applied to the other actuator 144 of the actuation system 140 as well. Further, the actuation system 140 can include additional or lesser number of actuators to assist with a functioning or movement of the mast assembly 124.

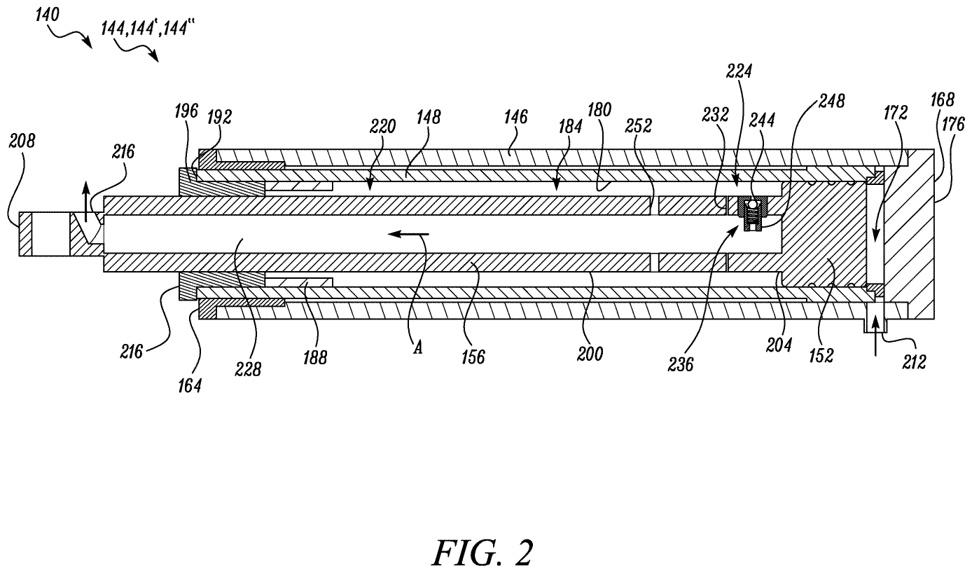

Referring to FIG. 2, the actuator 144 is discussed. The actuator 144 may be coupled between the frame 104 and the mast 128, as shown. The actuator 144 may be a hydraulic actuator 144 that includes at least one cylinder. It should be noted that the term “at least one cylinder” corresponds to a plurality of cylinders disposed in a telescopic relationship to each other. In the present embodiment, the hydraulic actuator 144 is a multi-stage hydraulic actuator 144. For example, as shown in FIG. 2, the hydraulic actuator 144 is a two-stage hydraulic actuator 144″ that includes a head cylinder 146 and a cylinder 148 received within the head cylinder 146. In addition, the two-stage hydraulic actuator 144″ (or the hydraulic actuator 144) includes a piston 152 and a rod 156.

The head cylinder 146 may define an open end 164 and a closed end 168, and a head cylinder channel 172 may be defined to extend between the open end 164 and the closed end 168. The head cylinder 146 may define a head cylinder end 176 adjacent to or at the closed end 168. The cylinder 148 may be insertable into the head cylinder channel 172 through the open end 164 to be disposed (slidably disposed) inside the head cylinder 146. Both the head cylinder 146 and the cylinder 148 may define an elongated profile and may be disposed in a linearly slidable or telescopic relationship with respect to each other. In one or more embodiments, the head cylinder 146 and the cylinder 148 may be the same device, and the cylinders (such as the cylinder 148) inserted between the head cylinder 146 and the rod 156 may be omitted.

The cylinder 148 may define an inner surface 180 defining a cylinder channel 184 and may include an end structure 188 arranged (e.g., immovably) on the inner surface 180. Further, the cylinder 148 may be closed off at one end 192, located away from the head cylinder end 176, by way of an end cap 196. Further, the piston 152 may be disposed inside the cylinder 148 in a slidable engagement (e.g., a linearly slidable engagement) with respect to the inner surface 180 of the cylinder 148. The piston 152 may be configured to move (e.g., slidably move) with respect to the inner surface 180, and thus the cylinder 148, between one end 192 of the cylinder 148 and the end structure 188 of the cylinder 148. The rod 156 may define a body 200 and may be coupled (e.g., fixedly coupled) to the piston 152 and thus may move along with a movement of the piston 152. The rod 156 defines a first rod end 204 at which the rod 156 is coupled to the piston 152 and a second rod end 208, which may be away from the piston 152 and remote to the head cylinder end 176 of the head cylinder 146.

The hydraulic actuator 144 may include an inlet 212 and an outlet 216. As an example, the inlet 212 may be provided or formed in the head cylinder 146, while the outlet 216 may be provided or formed in the rod 156. The inlet 212 may be used for introducing a fluid into the head cylinder 146 and the hydraulic actuator 144, while the outlet 216 may be used for releasing the fluid from the rod 156 and the hydraulic actuator 144. Other positions of the outlet 216 and/or the inlet 212 may be contemplated by someone in the art and which may achieve the same functions, as noted above, based on the details described in the present description. According to some embodiments, a cavity 220 may be defined between the piston 152 and the end structure 188 and said cavity 220 may be surrounded by the inner surface 180 of the cylinder 148 on one side and delimited by the rod 156 on the other side. The cavity 220 may be a variable cavity or may be one which varies as the piston 152 moves with respect to the end structure 188 within the cylinder channel 184.

According to an exemplary operation of the hydraulic actuator 144, an extension of the first rod end 204 with respect to the head cylinder end 176 (to achieve an extended position of the hydraulic actuator 144) may move the mast assembly 124 to the raised position, while a retraction of the first rod end 204 with respect to the head cylinder end 176 (to achieve a retracted position of the hydraulic actuator 144) may move the mast assembly 124 to the lowered position. As an example, the extension of the rod 156 with respect to the head cylinder 146 may be attained when the fluid is introduced into the head cylinder 146, while the retraction of the rod 156 with respect to the head cylinder 146 may be attained when the fluid is released from the head cylinder 146. Further, as an example, the head cylinder end 176 may be coupled to the frame 104 of the machine 100 and the second rod end 208 may be coupled to the mast assembly 124.

The forthcoming description will include discussions related to a system 224 for operating the hydraulic actuator 144. The system 224 includes a fluid chamber 228, one or more cushioning orifices 232, and a fluid pressure relief mechanism 236. The fluid chamber 228 may be disposed within the body 200 of the rod 156 and, in some embodiments, may be fluidly coupled with the outlet 216 defined by the rod 156. The one or more cushioning orifices include a cushioning orifice 232 extending through the body 200 of the rod 156 to fluidly couple the fluid chamber 228 with the cavity 220.

The fluid pressure relief mechanism 236 may include a pressure relief passageway 244 extending through the body 200 of the rod 156 and spanning between the fluid chamber 228 and the cavity 220. A cross-section of the pressure relief passageway 244 may be larger than a cross section of the cushioning orifice 232. The pressure relief passageway 244 may be located between the cushioning orifice 232 and the piston 152. The fluid pressure relief mechanism 236 may further include a pressure relief valve 248. The pressure relief valve 248 may be disposed within the pressure relief passageway 244 to selectively fluidly couple the fluid chamber 228 with the cavity 220. The pressure relief valve 248 may be a unidirectional pressure relief valve allowing fluid to flow from the cavity 220 to the fluid chamber 228 and may restrict a reverse movement of fluid from the fluid chamber 228 to the cavity 220. The pressure relief valve 248 may open when a pressure of the pressurized fluid in the cavity 220 or in the cushioning orifices 232 reaches a threshold pressure value. The pressure relief valve 248 may be a spring-operated relief valve, or may include any other type of relief valve, now known or in the future developed and a corresponding spring of the pressure relief valve 248 may be calibrated for actuation (i.e., to open the pressure relief valve 248) when a pressure applied to the spring may be at or above a spring pressure.

The rod 156 further includes a flow passageway 252 extending through the body 200 of the rod 156 to fluidly couple the fluid chamber 228 with the cavity 220. The flow passageway 252 may be used to relive a bulk of the pressurized fluid (present within the cavity 220) during a stroke or movement of the piston 152 towards the end structure 188. Although not limited, the cushioning orifice 232 may be disposed relatively close to the first rod end 204 than to the second rod end 208. In addition, the cushioning orifice 232 may be disposed between the flow passageway 252 and the first rod end 204, as shown.

### INDUSTRIAL APPLICABILITY

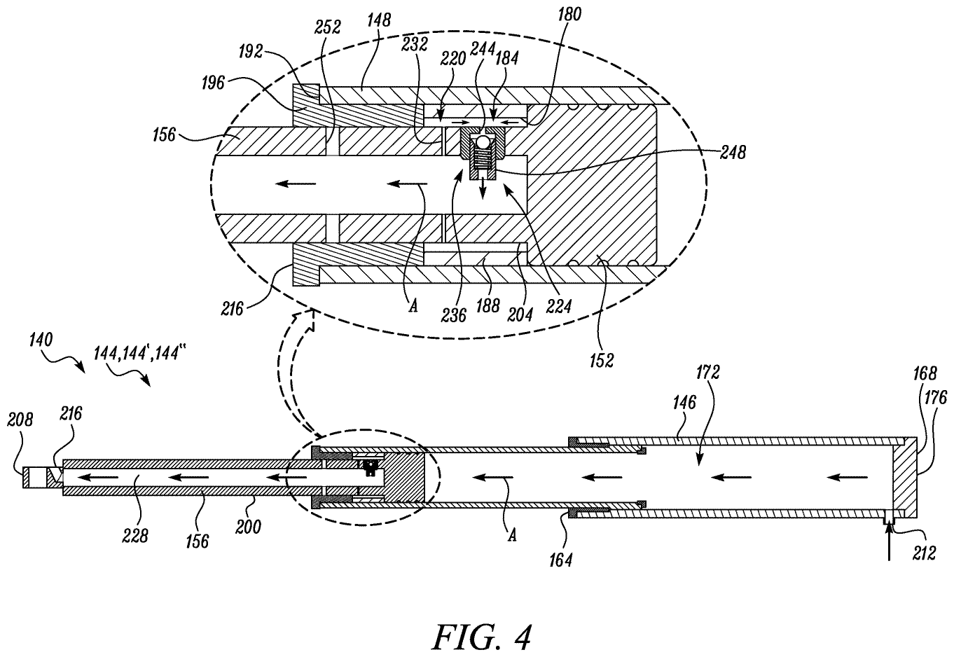

Referring to FIGS. 2, 3, and 4, an exemplary operation of the hydraulic actuator 144 will now be discussed. During operation, assuming that the hydraulic actuator 144 may be in the retracted position and the mast assembly 124 is in the lowered position or stowed position, a pressurized fluid may be present within the cavity 220. As the hydraulic actuator 144 may be needed to be moved from the retracted position to the extended position to move the mast assembly 124 to the raised position (e.g., to perform a drilling operation at the jobsite 102), fluid may enter into the hydraulic actuator 144 from the inlet 212 (as shown in FIG. 2). Once fluid enters into the head cylinder 146, the fluid may impinge upon the cylinder 148 and exert a force on the cylinder 148 which may push the cylinder 148 away from the head cylinder end 176 towards the open end 164 (see exemplary direction, A, of the movement).

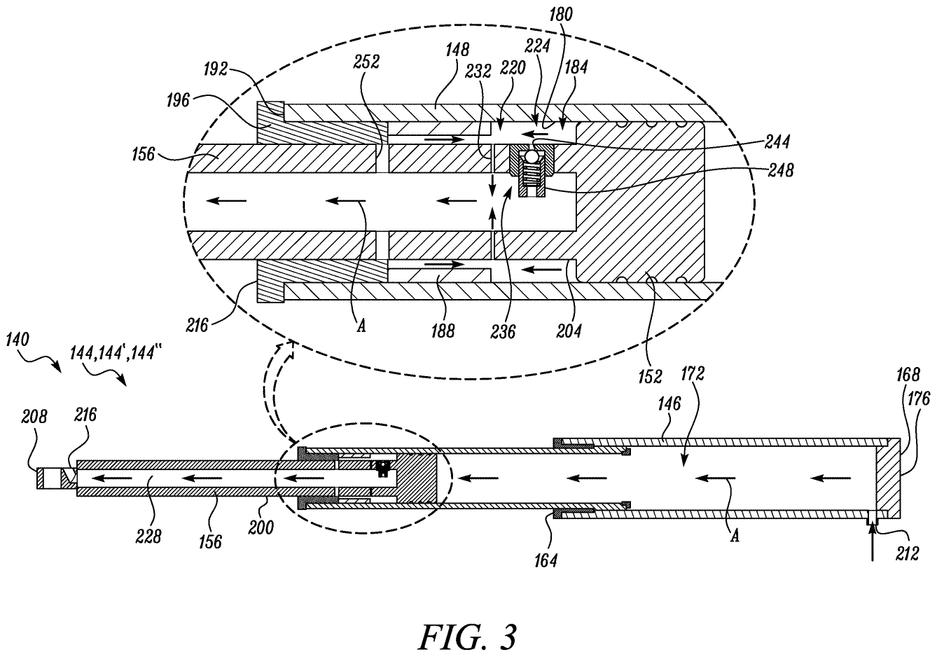

Simultaneous to a movement of the cylinder 148 or once the cylinder 148 has reached up to its maximum extended position outwardly to the head cylinder 146, the fluid may also impinge upon the piston 152 and may move or push the piston 152 (and the rod 156) with respect to the cylinder 148 to enable the piston 152 (and thus the rod 156) to move towards the end structure 188, outwardly of the cylinder 148 (as shown in FIG. 3). As the piston 152 (and thus the rod 156) moves towards the end structure 188, the pressurized fluid present inside the cavity 220 is forced out into the fluid chamber 228 through the flow passageway 252. The pressurized fluid is forced out through the flow passageway 252 as long as the flow passageway 252 remains open to each of the cavity 220 and the fluid chamber 228.

As the piston 152 continues to move towards the end structure 188, the flow passageway 252 may be overlapped by the end cap 196 of the cylinder 148 thus closing off the flow passageway 252 from the cavity 220. Owing to such closure, a first volume of pressurized fluid present inside the cavity 220 may route and flow out into the fluid chamber 228 through the cushioning orifice 232 although it is possible that some volume of pressurized fluid may exit out into the fluid chamber 228 even as the fluid is pushed out into the fluid chamber 228 through the flow passageway 252.

At this time, since the flow passageway 252 is closed, a continued movement of the piston 152 (and thus the rod 156) pushes out a first volume of pressurized fluid from the cavity 220 into the fluid chamber 228 through cushioning orifice 232 (e.g., at a relatively very slow rate). Thus, the cushioning orifice 232 provides an exit passage to the first volume of the pressurized fluid in the cavity 220 into the fluid chamber 228 during the movement of the piston 152 towards the end structure 188. Since the flow rate of fluid from the cavity 220 to the fluid chamber 228 may be relatively low (e.g., lower than what is achieved through the flow passageway 252), a pressure of the fluid in the cavity 220 increases as the piston 152 continues to move towards the end structure 188 of the cylinder 148. This pressure exerts a reactionary force against the movement of the piston 152 and prevents and cushions the piston 152 against an impact (e.g., hard impact) with the end structure 188.

As the piston 152 may continue to be pushed by the fluid entering into the head cylinder 146 (e.g., to move the hydraulic actuator 144 to the fully extended position), the pressure of the pressurized fluid inside the cavity 220 and/or in the cushioning orifice 232 may be further increased. As the pressure increases beyond a threshold pressure value, or as the pressure of the pressurized fluid in the cavity 220 and/or the cushioning orifice 232 meets or exceeds the spring pressure (of the pressure relief valve 248), the pressure relief valve 248 opens up and allows (i.e., relieve) a second volume of the pressurized fluid (in excess of the first volume of the pressurized fluid) to flow from the cavity 220 through the pressure relief passageway 244 into the fluid chamber 228. The fluid collected in the fluid chamber 228, at any point, may be expelled or released out of the fluid chamber 228 or the hydraulic actuator 144 through the outlet 216.

The flow of pressurized fluid through the pressure relief passageway 244 of the fluid pressure relief mechanism 236 reduces the intensification of the pressure or pressure build up in the cavity 220 and/or in the cushioning orifice 232. While the system 224 helps in cushioning the piston 152 against an impact with the end structure 188 of the cylinder 148, the system 224 also negates the effects of high-pressure conditions developed within the cavity 220 and/or the cushioning orifice 232 by relieving the high-pressure fluid from the cavity 220 of the hydraulic actuator 144 by way of the fluid pressure relief mechanism 236. Accordingly, the system 224 prevents excessive pressure from yielding the material of the piston 152, the rod 156, or surrounding components (e.g., the cylinder 148), thereby increasing a lifespan of the piston 152, rod 156, and/or the surrounding components (e.g., the cylinder 148). The system 224 may be applied in any hydraulic actuator (e.g., single stage actuators, or multi-stage actuators, and the like) and need not be limited to an application within the hydraulic actuator 144, and which in turn may be used in any work machine, such as, but not limited to, tractors, dozers, and other excavating and/or material handling machines.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A, B; C; A and B; A and C; B and C; A, B, and C; or multiple of any item such as A and A; B, B, and C; A, A, B, C, and C; etc.

It will be apparent to those skilled in the art that various modifications and variations can be made to the method and/or the system of the present disclosure without departing from the scope of the disclosure. Other embodiments will be apparent to those skilled in the art from consideration of the specification and practice of the method and/or the system disclosed herein. It is intended that the specification and examples be considered as exemplary only, with a true scope of the disclosure being indicated by the following claims and their equivalent.

1-10. (canceled)

11. A system for operating a hydraulic actuator, the system comprising:
a fluid chamber;
one or more cushioning orifices fluidly coupled between the fluid chamber and a cavity defined between a piston and an end structure of the hydraulic actuator, the one or more cushioning orifices providing an exit passage to a first volume of a fluid pressurized in the cavity into the fluid chamber during a movement of the piston towards the end structure to cushion the piston against an impact with the end structure; and
a fluid pressure relief mechanism configured to relieve a second volume of the fluid in excess of the first volume of the fluid when a pressure of the fluid in the one or more cushioning orifices or the cavity reaches or exceeds a threshold pressure value during the movement of the piston towards the end structure.

12. The system of claim 11, wherein the second volume of the fluid is relieved into the fluid chamber.

13. The system of claim 11, wherein the piston is coupled to a rod, and wherein the fluid chamber is defined within the rod.

14. The system of claim 13, wherein the one or more cushioning orifices extend through a body of the rod to fluidly couple the fluid chamber with the cavity.

15. The system of claim 13, wherein the fluid pressure relief mechanism includes a pressure relief valve and a pressure relief passageway extending through a body of the rod to fluidly couple the fluid chamber with the cavity, and wherein the pressure relief valve is disposed within the pressure relief passageway and includes a unidirectional valve allowing the fluid to flow from the cavity to the fluid chamber.

16. The system of claim 15, wherein the pressure relief passageway is located between the one or more cushioning orifices and the piston.

17. The system of claim 15, wherein a cross-section of the pressure relief passageway is larger than a cross-section of each of the one or more cushioning orifices.

18. The system of claim 13 further including one or more flow passageways extending through a body of the rod to fluidly couple the fluid chamber with the cavity.

19. The system of claim 11, wherein the hydraulic actuator includes a multi-stage hydraulic actuator including a plurality of cylinders disposed in a telescopic relationship to each other.

20. A hydraulic actuator, comprising:
at least one cylinder defining an end structure;
a piston moveable with respect to the at least one cylinder and defining a cavity with respect to the end structure; and
a system for operating the hydraulic actuator, the system comprising:
a fluid chamber;
one or more cushioning orifices fluidly coupled between the fluid chamber and the cavity, the one or more cushioning orifices providing an exit passage to a first volume of a fluid pressurized in the cavity into the fluid chamber during a movement of the piston towards the end structure to cushion the piston against an impact with the end structure; and
a fluid pressure relief mechanism configured to relieve a second volume of the fluid in excess of the first volume of the fluid when a pressure of the fluid in the one or more cushioning orifices or the cavity reaches or exceeds a threshold pressure value during the movement of the piston towards the end structure.

21. The hydraulic actuator of claim 20, wherein the hydraulic actuator includes a multi-stage hydraulic actuator, and the at least one cylinder corresponds to a plurality of cylinders disposed in a telescopic relationship to each other.

22. The hydraulic actuator of claim 20, wherein the second volume of the fluid is relieved into the fluid chamber.

23. The hydraulic actuator of claim 20, wherein the piston is coupled to a rod, and the fluid chamber is defined within the rod, and wherein the one or more cushioning orifices extend through a body of the rod to fluidly couple the fluid chamber with the cavity.

24. The hydraulic actuator of claim 23, wherein the fluid pressure relief mechanism includes a pressure relief valve and a pressure relief passageway extending through the body of the rod to fluidly couple the fluid chamber with the cavity, wherein the pressure relief passageway is disposed between the one or more cushioning orifices and the piston, wherein a cross-section of the pressure relief passageway is larger than a cross-section of each of the one or more cushioning orifices, and wherein the pressure relief valve is disposed within the pressure relief passageway and includes a unidirectional valve allowing the fluid to flow from the cavity to the fluid chamber.

25. The hydraulic actuator of claim 23, wherein the system includes one or more flow passageways extending through the body of the rod to fluidly couple the fluid chamber with the cavity.

26. A work machine comprising:
a frame;
a work implement;
a hydraulic actuator configured to move the work implement with respect to the frame, the hydraulic actuator including;
at least one cylinder defining an end structure;
a piston moveable with respect to the at least one cylinder and defining a cavity with respect to the end structure; and
a system for operating the hydraulic actuator, the system comprising:
a fluid chamber;
one or more cushioning orifices fluidly coupled between the fluid chamber and the cavity, the one or more cushioning orifices providing an exit passage to a first volume of a fluid pressurized in the cavity into the fluid chamber during a movement of the piston towards the end structure to cushion the piston against an impact with the end structure; and
a fluid pressure relief mechanism configured to relieve a second volume of the fluid in excess of the first volume of the fluid when a pressure of the fluid in the one or more cushioning orifices or the cavity reaches or exceeds a threshold pressure value during the movement of the piston towards the end structure.

27. The work machine of claim 26, wherein the second volume of the fluid is relieved into the fluid chamber.

28. The work machine of claim 26, wherein the piston is coupled to a rod, wherein the fluid chamber is defined within the rod, and wherein the one or more cushioning orifices extend through a body of the rod to fluidly couple the fluid chamber with the cavity.

29. The work machine of claim 28, wherein the fluid pressure relief mechanism includes a pressure relief valve and a pressure relief passageway extending through the body of the rod to fluidly couple the fluid chamber with the cavity, wherein the pressure relief passageway is disposed between the one or more cushioning orifices and the piston, wherein a cross-section of the pressure relief passageway is larger than a cross-section of each of the one or more cushioning orifices, and wherein the pressure relief valve is disposed within the pressure relief passageway and includes a unidirectional valve allowing the fluid to flow from the cavity to the fluid chamber.

30. The work machine of claim 28, wherein the system includes a flow passageway extending through the body of the rod to fluidly couple the fluid chamber with the cavity.
